(19) United States
(12) Patent Application Publication
(10) Pub. No.: US 2014/0347596 A1
(43) Pub. Date: Nov. 27, 2014

(54) BACKLIGHT UNIT AND LIQUID-CRYSTAL DISPLAY DEVICE

(71) Applicant: Sharp Kabushiki Kaisha, Osaka-shi, Osaka (JP)

(72) Inventor: Jo Ikuta, Osaka-shi (JP)

(73) Assignee: SHARP KABUSHIKI KAISHA a corporation

(21) Appl. No.: 14/362,437

(22) PCT Filed: Nov. 29, 2012
(86) PCT No.: PCT/JP2012/080813

§ 371 Date: Jun. 3, 2014

(30) Foreign Application Priority Data
Dec. 6, 2011 (JP) 2011-267150

(51) Int. Cl. F21V 8/00; G02F 1/1333

(52) U.S. Cl. CPC G02B 6/0016; G02B 6/0091; G02F 1/133308
USPC 349/58; 362/611

(57) ABSTRACT

To alleviate brightness unevenness arising from optical sheet bending or wrinkling, as well as brightness unevenness caused by light leakage, and improve light usage emitted by a light source unit, provided is a backlight unit (1) comprising a light guide plate alignment unit (5) which is positioned to maintain a given location with respect to a back chassis (10), latches with a depression part (23), and further comprising a depression part (51) which is formed such that a portion of an optical sheet (4) is inserted.

### TECHNICAL FIELD

The present invention relates to an edge light type backlight unit and a liquid-crystal display device including the same.

### BACKGROUND ART

A liquid-crystal display device includes a liquid-crystal panel unit and a backlight unit disposed behind the liquid-crystal panel unit, and the liquid-crystal panel unit modulates light from the backlight unit, thus causing a video image to be displayed on a front surface of the liquid-crystal panel unit.

As the backlight unit used in the liquid-crystal display device, there is used a light guide plate type (edge light type) backlight unit including a light guide plate and a light source from which light is made to enter the light guide plate from a side surface of the light guide plate. The following describes such an edge light type backlight unit. The edge light type backlight unit includes a light source unit in which a plurality of LEDs are arranged in line, a light guide plate that receives, on a light reception surface at a side surface thereof, light outputted from the light source unit and emits planar light from a light emission surface at one principal surface thereof (a principal surface thereof on a front side), an optical sheet disposed adjacently to the light emission surface of the light guide plate, and a reflection sheet disposed adjacently to a surface of the light guide plate on an opposite side to the light emission surface. Further, these members are disposed inside a back chassis.

Conventionally, the edge light type backlight unit has had difficulty, due to its structure in which light enters the light guide plate from a side surface of the light guide plate, in emitting large planar light having a uniform brightness distribution. Because of this, the edge light type backlight unit has been used in compact liquid-crystal display devices such as a monitor for a notebook personal computer and a monitor for a game machine. In recent years, thanks to improved performance of a light guide plate or an optical sheet, increased brightness of an LED used as a light source, and so on, the edge light type backlight unit has become capable of emitting large-area planar light having a uniform brightness distribution. Furthermore, recent years have seen a growing demand that the liquid-crystal display device be reduced in thickness and size, which also has led to increasing adoption of the edge light type backlight unit in the liquid-crystal display device of a large-sized type such as a type used in a large-sized television set.

In a liquid-crystal display device including an edge light type backlight unit as described above, light from a light source unit is reflected repeatedly inside a light guide plate, and thus the light is widely spread in plane and homogenized. There is a case, however, where light emitted from the light source unit fails to enter the light guide plate (leakage light is generated) and directly enters a liquid-crystal panel unit. At a portion of the liquid-crystal panel unit where the leakage light has entered, brightness unevenness may occur, which is a phenomenon that brightness becomes higher at the portion than at any other portion of the liquid-crystal panel unit, resulting in deterioration in quality.

As a solution to this, in a liquid-crystal display device described in JP-A-2002-174811, a light blocking tape having an antireflection function is attached to a periphery of an opening window of a housing disposed between an illumination unit (a backlight unit in the present invention) and a liquid-crystal panel (a liquid-crystal panel unit in the present invention). With the light blocking tape thus attached, it is possible to reduce leakage light, which is reflected repeatedly between a glass substrate and the housing, and thus to suppress deterioration in quality of the liquid-crystal display device.

Furthermore, in the edge light type backlight unit, it is likely that a positional misalignment between the light source unit and the light guide plate leads to a decrease in brightness of emitted light and the occurrence of brightness unevenness. In order to avoid this, a cut-out portion is formed at a surface of the light guide plate different from a surface thereof opposed to the light source unit and is engaged with a positioning protrusion portion disposed at a frame so that accurate positioning of the light guide plate with respect to the light source unit is achieved.

### LIST OF CITATIONS

### Patent Literature

Patent Document 1: JP-A-2009-123557

### SUMMARY OF THE INVENTION

### Technical Problem

Due to heat from the light source unit and so on, the light guide plate is heated to be deformed (expanded and/or bent). In a case where the light guide plate is securely fastened, deformation-induced stress is generated, resulting in deformation such as wrinkling or deflection. As a solution to this, in order to suppress heat-induced stress in the light guide plate, a gap is formed between the cut-out portion of the light guide plate and the positioning protrusion portion so that even when the light guide plate is deformed, generation of thermal stress is prevented.

The cut-out portion of the light guide plate includes a surface that is opposed to the positioning protrusion portion and to the light reception surface of the light guide plate where light from the light source unit enters, and is opposed to the light reception surface, so that it is likely that light having a high luminous flux density leaks therein. Further, the gap is formed between the surface opposed to the light reception surface and the positioning protrusion portion, so that it is likely that light is emitted from the gap to an outside of the light guide plate.

Furthermore, similarly to the light guide plate, an optical sheet also is deformed due to heat. The optical sheet is formed in such a size that, even when deformed, it does not come in contact with the positioning protrusion portion, and is disposed in proximity to the light emission surface of the light guide plate such that a gap is formed between itself and the positioning protrusion portion. Hence, light that has leaked from the gap between the cut-out portion and the positioning protrusion portion does not pass through the optical sheet, and brightness thereof, therefore, is adjusted only insufficiently, which results in brightness unevenness of planar light emitted from the backlight unit.

In this respect, there has been proposed a configuration in which a light blocking member is disposed so as to cover a front side of the positioning protrusion portion so that entry of leakage light into the liquid-crystal panel unit is suppressed. In this configuration, however, the positioning protrusion portion in its vicinity has a complex shape, and for conformance thereto, the light blocking member also needs to be formed in a complex shape, which leads to an increase in work and cost required for manufacturing. Furthermore, with this light blocking member thus disposed, a part of light emitted from the light source unit is blocked, and light use efficiency is decreased correspondingly.

With the above in view, it is an object of the present invention to provide a backlight unit that suppresses brightness unevenness due to thermal stress in a light guide plate or deflection or wrinkling of an optical sheet and brightness unevenness due to leakage light and thus can provide increased use efficiency of light outputted from a light source unit, and a liquid-crystal display device using the backlight unit.

### Solution to the Problem

In order to achieve the above-described object, the present invention provides a backlight unit including: a light guide plate that includes, at a side portion thereof, a light reception surface that receives light and, at a principal surface thereof on a front side, a light emission surface from which planar light is emitted, and has a cut-out portion formed at a side portion thereof different from the side portion at which the light reception surface is formed; a light source unit that irradiates the light reception surface with light; a back chassis on which the light source unit and the light guide plate are disposed; an optical sheet that is disposed in proximity to the light emission surface of the light guide plate and covers a front side of the cut-out portion; and a light guide plate positioning portion that is disposed so as to be maintained at a constant position with respect to the back chassis, is engaged with the cut-out portion, and has a slit groove formed to receive insertion of a part of the optical sheet.

According to this configuration, the optical sheet is inserted into the slit groove of the light guide plate positioning portion, and thus the front side of the cut-out portion of the light guide plate can be covered with the optical sheet. With this configuration, even when light leaks from a gap between the cut-out portion of the light guide plate and the light guide plate positioning portion, brightness of the light can be adjusted by using the optical sheet, and thus brightness unevenness can be suppressed.

Furthermore, light that has leaked from the cut-out portion is, instead of being blocked, diffused by using the optical sheet and used in that state, so that it is possible to suppress a decrease in use efficiency of light from a light source and thus to reduce power consumption by the light source unit.

The above-described configuration may be such that the optical sheet has a pair of extended portions that extend so as to make contact with both sides of the light guide plate positioning portion.

The above-described configuration may be such that a light guide plate holding-down portion is provided that presses, toward the back chassis, a portion of the light emission surface of the light guide plate other than a portion of the light emission surface at which the cut-out portion is formed, and the optical sheet is formed so as not to make contact with the light guide plate holding-down portion.

The above-described configuration may be such that the light guide plate holding-down portion includes a pair of rod-shaped members that hold down the light guide plate, and the pair of rod-shaped members are disposed side by side with a gap provided therebetween in an area overlapping the extended portions of the optical sheet in front view.

A liquid-crystal display device can be provided that includes: the backlight unit configured as above; a liquid-crystal panel unit that is disposed in front of the backlight unit; and an appearance frame that covers an outer edge portion of each of the backlight unit and the liquid-crystal panel unit. In the liquid-crystal display device, the light guide plate positioning portion is mounted and fastened to the appearance frame.

The above-described configuration may be such that the appearance frame includes a cover portion that covers an outer periphery of the backlight unit, and the light guide plate positioning portion is fastened to the cover portion.

The above-described configuration may be such that the appearance frame includes a holding-down portion that presses an outer periphery of a front surface of each of the backlight unit and the liquid-crystal panel unit, and the light guide plate holding-down portion is fastened to the holding-down portion.

### Advantageous Effects of the Invention

According to the present invention, there can be provided a backlight unit that suppresses brightness unevenness due to thermal stress in a light guide plate or deflection or wrinkling of an optical sheet and brightness unevenness due to leakage light and thus can provide increased use efficiency of light outputted from a light source unit, and a liquid-crystal display device using the backlight unit.

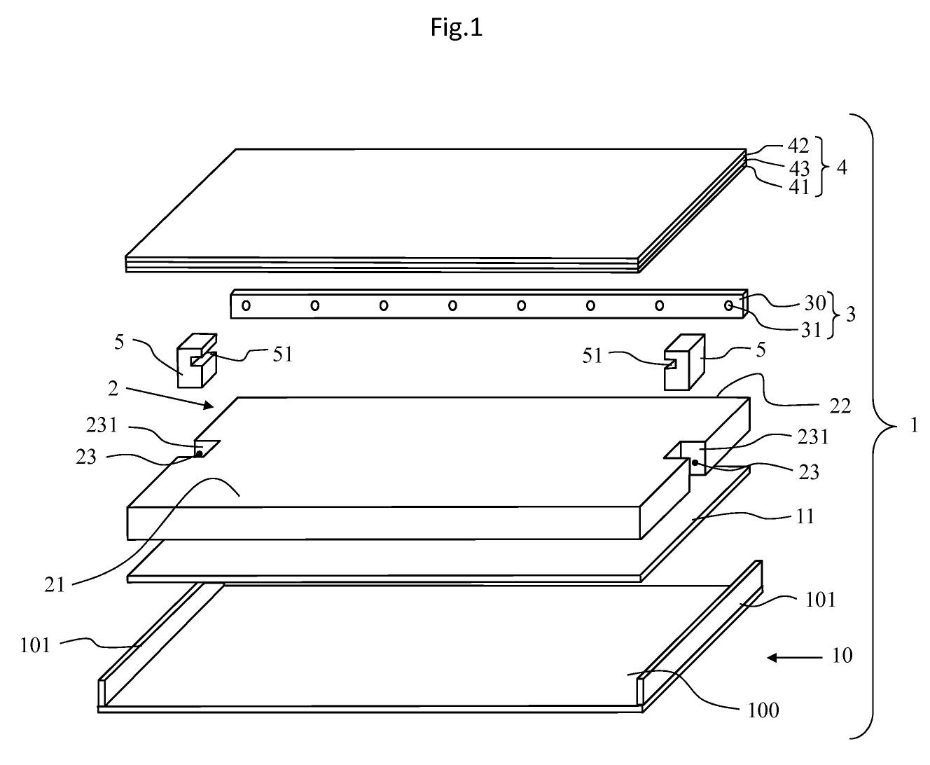

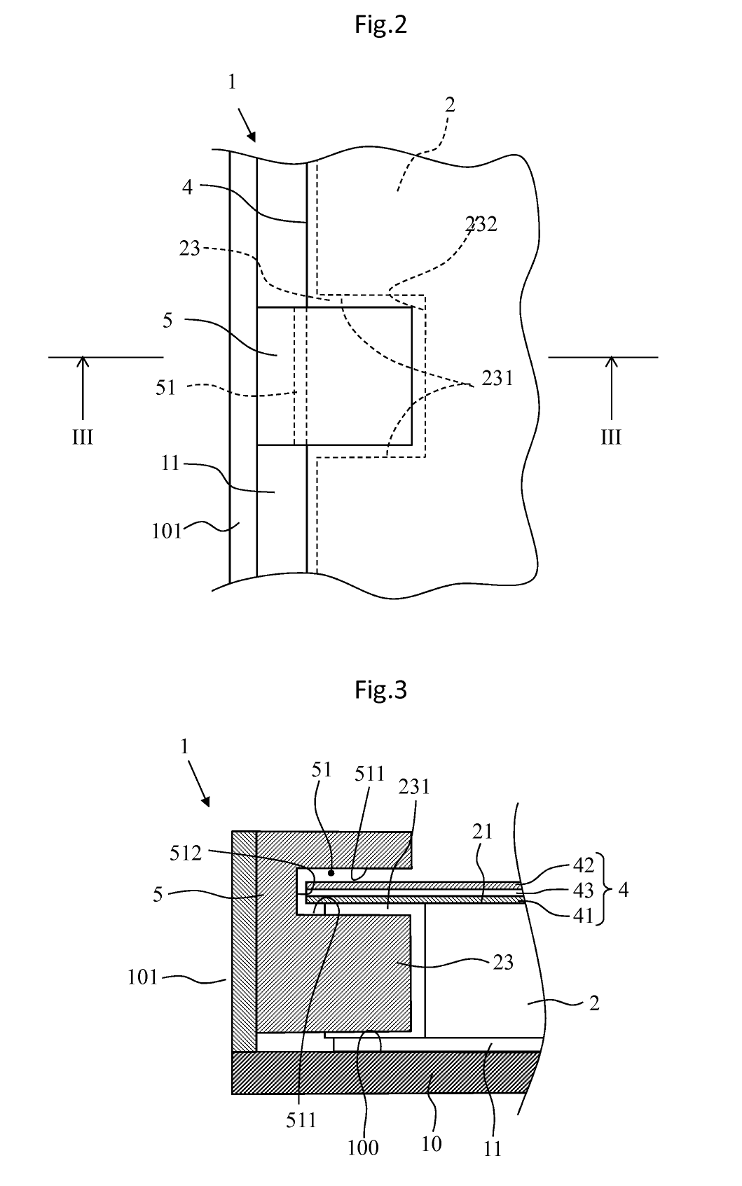

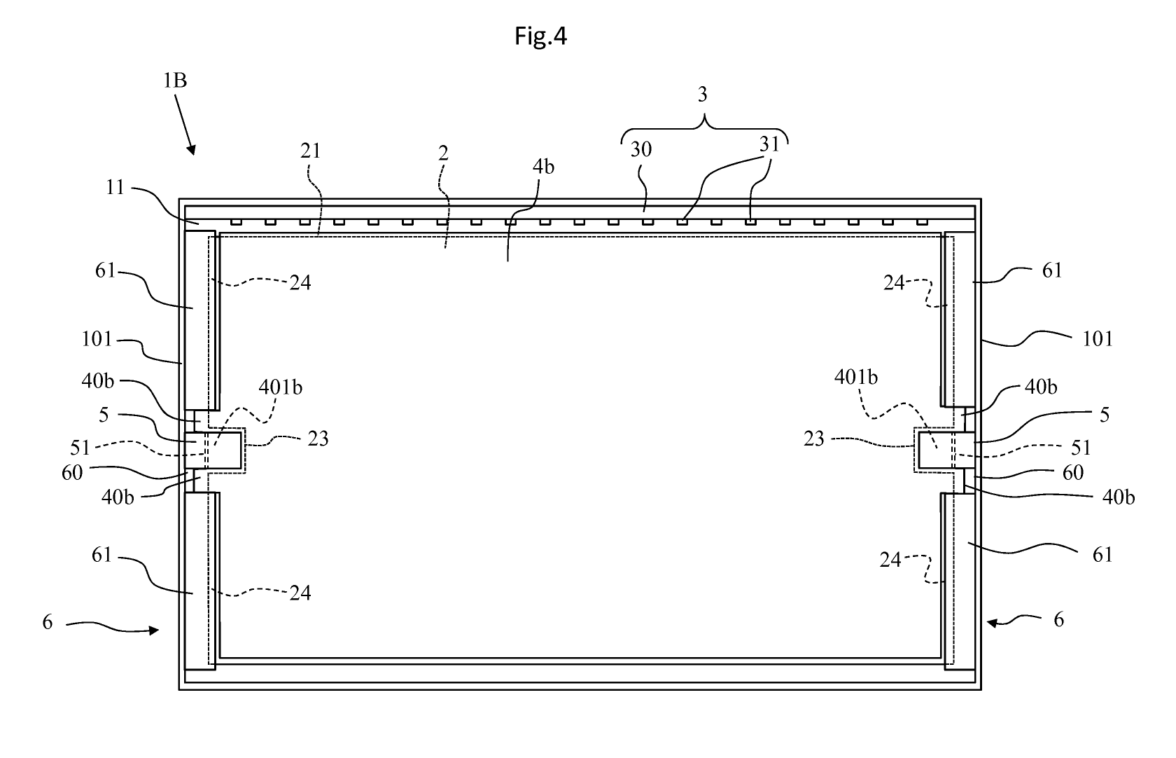

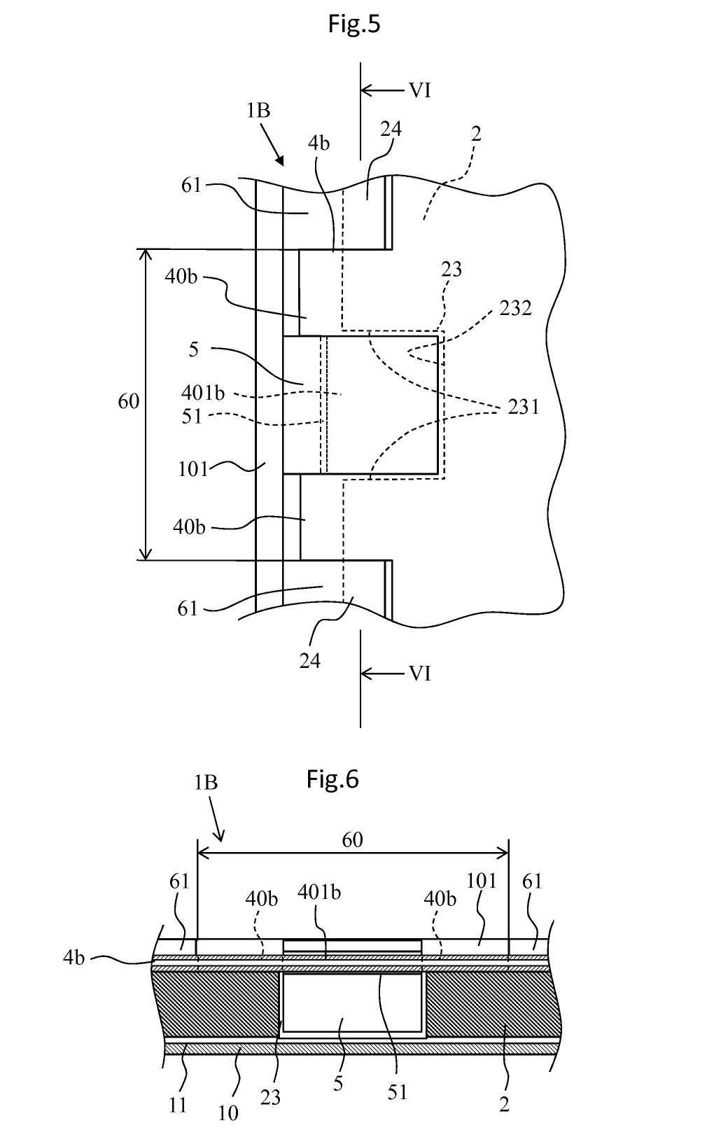

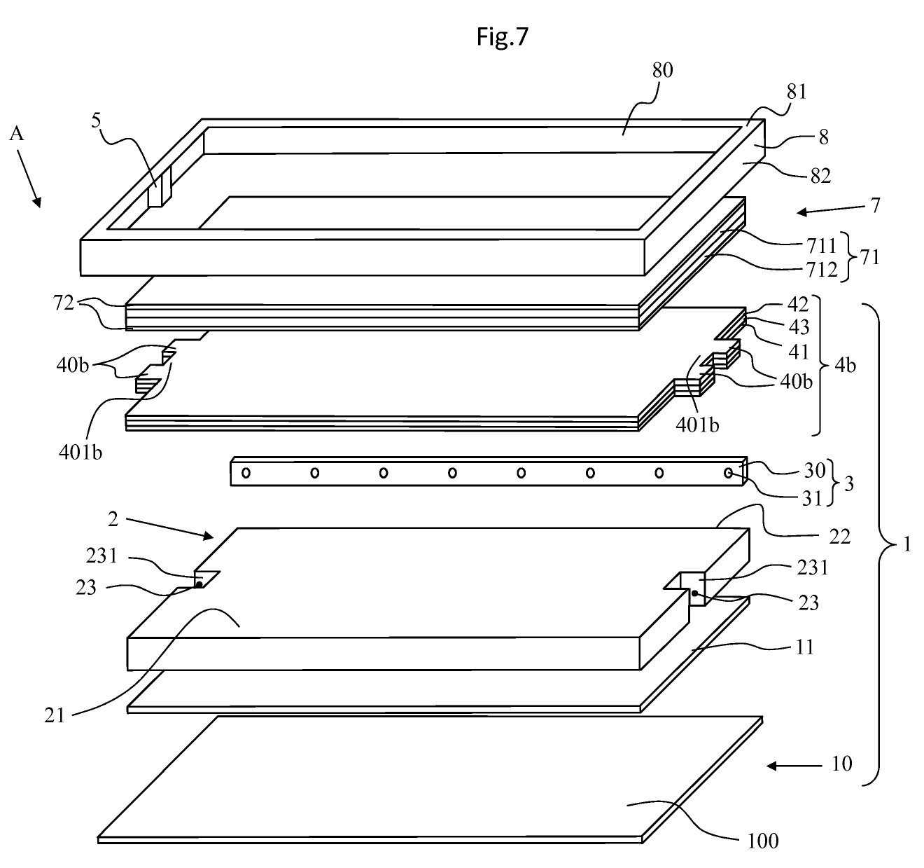

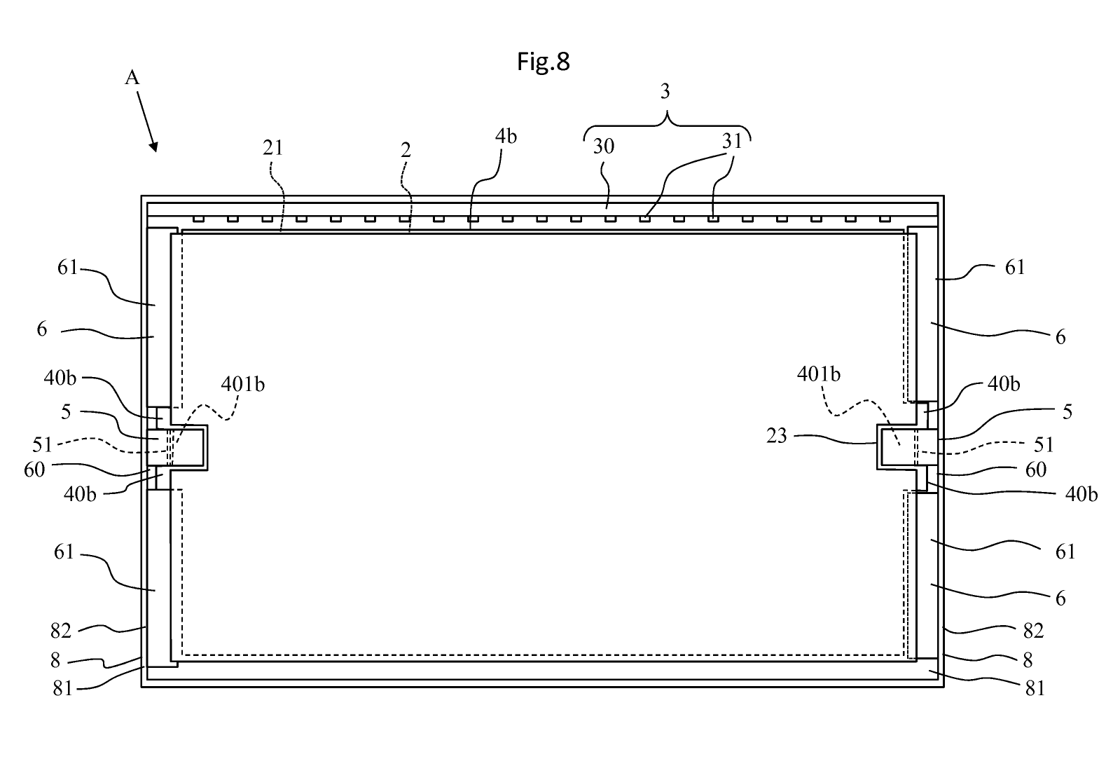

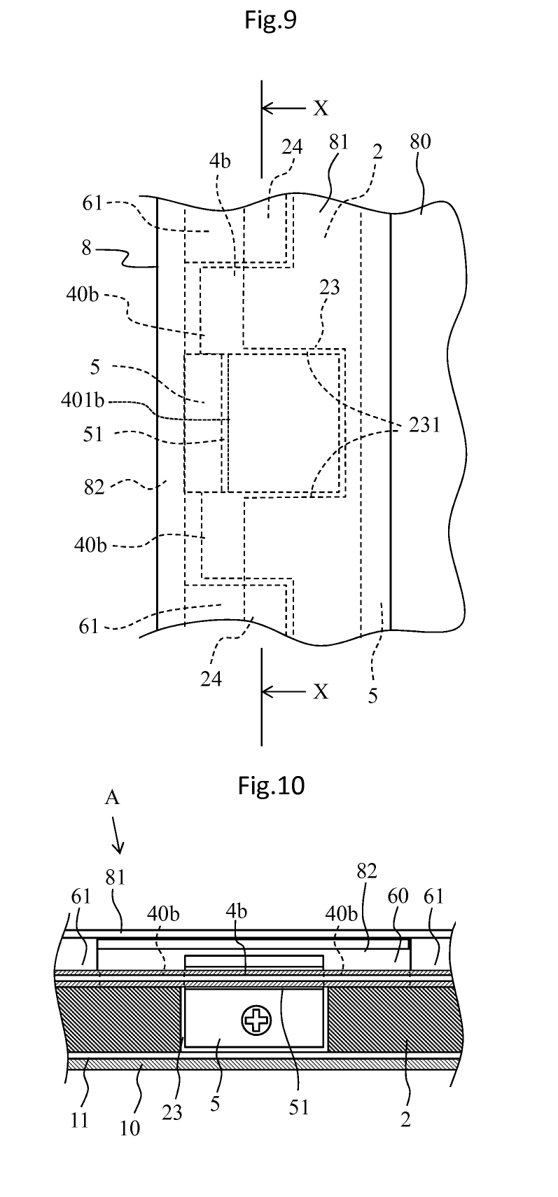

### BRIEF DESCRIPTION OF DRAWINGS

[FIG. 1] is an exploded perspective view of one example of a backlight unit according to the present invention.

[FIG. 2] is an enlarged front view of a vicinity of a light guide plate positioning portion of the backlight unit according to the present invention.

[FIG. 3] is an enlarged sectional view of the backlight unit shown in FIG. 2, as taken on line III-III.

[FIG. 4] is a front view of another example of the backlight unit according to the present invention.

[FIG. 5] is an enlarged view of a vicinity of a light guide plate positioning portion of the backlight unit shown in FIG. 4.

[FIG. 6] is a sectional view of the backlight unit shown in FIG. 5, as taken on line VI-VI.

[FIG. 7] is an exploded perspective view of a liquid-crystal display device according to the present invention.

[FIG. 8] is a rear view of the liquid-crystal display device according to the present invention in a state where a back chassis has been removed therefrom.

[FIG. 9] is an enlarged view of a light guide plate positioning portion of the liquid-crystal display device according to the present invention.

[FIG. 10] is a sectional view of the liquid-crystal display device shown in FIG. 9, as taken on line X-X.

### DESCRIPTION OF EMBODIMENTS

Hereinafter, embodiments of the present invention will be described with reference to the appended drawings.

### First Embodiment

FIG. 1 is an exploded perspective view of one example of a backlight unit according to the present invention. In a backlight unit shown in FIG. 1, it is assumed that an upper side of the plane of the figure is a front side, and a lower side of the plane of the figure is a rear side. Furthermore, unless otherwise specified, the following description refers to the front side or the rear side with reference to a state shown in FIG. 1.

As shown in FIG. 1, a backlight unit 1 is an illumination device that emits planar light such as for use as backlight for a liquid-crystal display device. The backlight unit 1 includes a back chassis 10, a reflection sheet 11, a light guide plate 2, a light source unit 3, an optical sheet 4, and a light guide plate positioning portion 5.

The back chassis 10 is a member rectangular in front view and has a bottom surface portion 100 in the shape of a rectangle. As shown in FIG. 1, in the backlight unit 1, from the rear side, the reflection sheet 11, the light guide plate 2, and the optical sheet 4 are disposed in this order. The reflection sheet 11 is a member that is disposed in contact with the bottom surface portion 100 and reflects, back to the light guide plate 2, light emitted from the light source unit 3 or light that has leaked from the light guide plate 2. While, as the reflection sheet 11, for example, a resinous sheet painted white is used, there is no limitation thereto, and any type of sheet or film configured to be able to reflect light efficiently can be adopted.

The light guide plate 2 is formed by molding a resin having a light transmitting property, such as polymethyl methacrylate (PMMA) or polycarbonate, into the shape of a flat plate. Resins that can be used are not limited to these types, and any type of resin that has a light transmitting property and can be formed in the shape of a flat plate can be adopted.

As shown in FIG. 1, the light guide plate 2 is a flat plate member in the shape of a rectangle in plan view. The light guide plate 2 has a configuration in which a principal surface thereof on the front side is used as a light emission surface 21, and one of side surfaces thereof in a short length direction is used as a light reception surface 22 that receives light from the light source unit 3. Moreover, the light guide plate 2 has a rectangular cut-out portion 23 formed at a center portion of each of both end portions thereof in a long length direction. The cut-out portion 23 is used as an engagement portion to be engaged with the light guide plate positioning portion 5. A relationship between the light guide plate 2 and the light guide plate positioning portion 5 will be described later.

The light source unit 3 includes an elongated substrate 30 that is disposed so as to be opposed to the light reception surface 22 and a plurality of LEDs 31 that are linearly arrayed on the substrate 30. While in the light source unit 3, the LEDs 31 are arrayed at equal intervals, an interval between each adjacent pair of them may vary from part to part. The substrate 30 is mounted to the back chassis 10 such that the LEDs 31 are opposed to an inner side of the backlight unit 1, i.e. to the light reception surface 22 of the light guide plate 2. Thus, light outputted from the LEDs 31 enters the light reception surface 22. Though not shown in the figure, the back chassis 10 includes a holding portion that holds the substrate 30 of the light source unit 3. While, as a light source, the LEDs 31 are adopted, there is no limitation thereto, and any type of light source configured to make light enter a light guide plate and to be able to cause planar light to be taken out can adopted.

Light that has entered from the light reception surface 22 is reflected (diffusely reflected) repeatedly inside the light guide plate 2 and thus is diffused inside the light guide plate 2. At this time, a part of the light inside the light guide plate 2 is emitted from the light emission surface 21 to the outside, while a remaining part of the light is reflected to an inside of the light guide plate 2. That is, as light that has entered from the light reception surface 22 is reflected repeatedly by inner surfaces of the light guide plate 2, a part of the light is emitted from the light emission surface 21, so that planar light having a uniformized brightness distribution is emitted from the light emission surface 21. For the purpose of further uniformizing a brightness distribution of planar light emitted from the light emission surface 21, the optical sheet 4 is disposed adjacently to the light emission surface 2.

The optical sheet 4 is an optical member for uniformizing a brightness distribution of planar light emitted from the light emission surface 21 of the light guide plate 2. The optical sheet 4 includes a diffusion sheet 41 that diffuses light that is being transmitted therethrough, a brightness enhancement sheet (DBEF) 42 that enhances brightness, and a prism sheet 43 that sets light that is being transmitted therethrough to be directed in one direction, i.e. changes a direction of light that has obliquely entered so that the light is directed to the front side. Any optical sheet member having an optical characteristic other than these also may be used. While, for the sake of convenience, the reflection sheet 11 and the optical sheet 4 of the backlight unit 1 shown in FIG. 1 are shown to be thick, in an actual form of the backlight unit 1, they are each formed of a thin member.

A description is given of the backlight unit according to the present invention with reference to other ones of the drawings. FIG. 2 is an enlarged front view of a vicinity of a light guide plate positioning portion of the backlight unit according to the present invention, and FIG. 3 is an enlarged sectional view of the backlight unit shown in FIG. 2, as taken on line III-III.

As shown in FIG. 2, in the backlight unit 1, the light guide plate 2 has the cut-out portion 23 formed at the center portion of each of both the end portions thereof in the long length direction. The light guide plate positioning portion 5 is disposed inside the cut-out portion 23, and thus positioning of the light guide plate 2 is achieved. As shown in FIGS. 1 and 2, the cut-out portion 23 has a shape formed by connecting two surfaces (after-mentioned inner side surfaces 231) thereof parallel to end surfaces of the light guide plate 2 in the short length direction via a surface 232 thereof parallel to end surfaces of the light guide plate 2 in the long length direction.

As shown in FIG. 3, the light guide plate positioning portion 5 is mounted and fastened to a mounting portion 101 that is engaged with each of short sides of the back chassis 10. The mounting portion 101 may be formed integrally with the back chassis 10 or may be a member separable from the back chassis 10. As the mounting portion 101, there can be adopted any type of member that can hold the light guide plate positioning portion 5 such that the light guide plate positioning portion 5 and the back chassis 10 are maintained in a constant positional relationship. Further, the light guide plate positioning portion 5 also has surfaces parallel respectively to the surfaces of the cut-out portion 23. The cut-out portion 23 configured as above and the light guide plate positioning portion 5 are engaged with each other, and thus positioning of the light guide plate 5 with respect to the back chassis 10 can be achieved.

Further, the cut-out portion 23 is formed such that a gap is formed between itself and opposed ones of the surfaces of the light guide plate positioning portion 5. The gap has such a width that the light guide plate 2 is positioned within a preset range with respect to the back chassis and that, even when the light guide plate 2 is thermally deformed, the light guide plate 2 and the light guide plate positioning portion 5 are prevented from coming in contact with each other, or even in a case where such contact occurs, it is unlikely that thermal stress is generated in the light guide plate 2.

The cut-out portion 23 is formed as above, and the cut-out portion 23 and the light guide plate positioning portion 5 are engaged with each other, so that even when the light guide plate 2 is thermally deformed, it is possible to suppress generation of thermal stress in the light guide plate 2. Also, movements of the light guide plate 2 in the long length direction and in the short length direction are restricted, and thus, for example, it is possible to suppress a situation where the light guide plate 2 moves in the short length direction to cause a light reception surface 21 and the light source unit 3 (particularly, the LEDs 31) to come in contact with each other.

Furthermore, as shown in FIG. 3, the light guide plate positioning portion 5 is mounted to the mounting portion 101, while being in non-contact with the back chassis 10. This makes it possible for the reflection sheet 11 to be disposed so as to extend further between a rear side of the light guide plate positioning portion 5 and the back chassis 10. With this configuration, light that has leaked from the cut-out portion 23 toward the back chassis 10 also can be reflected back into the light guide plate 2. In this sense, it is possible to further increase use efficiency of light emitted from the light source unit 3.

Further, the light guide plate positioning portion 5 includes a portion protruding to the front side of the backlight unit 1 and a slit groove 51 at a surface thereof facing inward (a surface thereof facing a center of the light guide plate 2 in front view). As shown in FIG. 3, the slit groove 51 is a cut-out portion rectangular in cross section formed by connecting, when the light guide plate positioning portion 5 is mounted to the backlight unit 1, two surfaces (511) thereof parallel to the bottom surface 100 of the back chassis 10 via a surface thereof (deepest surface 512) parallel to the mounting portion 101. The slit groove 51 is configured so that, when the light guide plate positioning portion 5 is engaged with the cut-out portion 23 of the light guide plate 2, the light emission surface 21 of the light guide plate 2 is positioned, in a thickness direction of the light guide plate 2, between either of the two surfaces 511 of the slit groove 51 parallel to the bottom surface of the back chassis 10 and the bottom surface of the back chassis 10.

When the light guide plate 2 is disposed on the back chassis 10 so that positioning thereof with respect to the back chassis 10 is achieved, and the optical sheet 4 is disposed so as to cover the light emission surface 21 of the light guide plate 2, a part of the optical sheet 4 is inserted into the slit groove 51 of the light guide plate positioning portion 5. That is, in front view, a portion of the optical sheet 4 overlapping the cut-out portion 23 is disposed inside the slit groove 51, so that, in front view, the cut-out portion 23 is covered with the optical sheet 4.

A description is given of details of the light guide plate 2, the optical sheet 4, and the light guide plate positioning portion 5 with reference to the appended drawings. The description is directed first to planar light provided by the backlight unit 1. Planar light emitted from the light emission surface 21 of the light guide plate 2 passes through the optical sheet 4, as a result of which uniformity (homogeneity) of a brightness distribution is increased, and a light emission direction is set to one direction, so that increased brightness is provided.

As shown in FIG. 2, the cut-out portion 23 for positioning the light guide plate 2 has the inner side surfaces 231 opposed to the light reception surface 22 (in FIG. 2, the surfaces formed to be parallel to each other) of the light guide plate 2. It is likely that light that has entered from the light reception surface 22 leaks from the inner side surfaces 231, while being in a state of not being attenuated or not substantially attenuated, in other words, in a state of maintaining a high luminous flux density. Further, the gap is formed between the inner surfaces of the cut-out portion 23 of the light guide plate 2 and the light guide plate positioning portion 5, and light that has leaked from the inner side surfaces 231 is emitted from this gap to the front side.

In the backlight unit 1, the optical sheet 4 is disposed in the slit groove 51 of the light guide plate positioning portion 5 and covers a front side of the cut-out portion 23. With this configuration, light that has leaked from the cut-out portion 23 and travels from the gap between the cut-out portion 23 and the light guide plate positioning portion 5 to the front side passes through the optical sheet 4. Thus, similarly to light emitted from the light emission surface 21 of the light guide plate 2, light that has leaked from the cut-out portion 23 also is homogenized by using the optical sheet 4, and thus the occurrence of brightness unevenness of planar light is suppressed. Furthermore, leakage light form the cut-out portion 23 also is homogenized by using the optical sheet 4 and used in that state, and thus use efficiency of light from the light source is high, so that energy consumption can be reduced correspondingly.

In the backlight unit 1, the optical sheet 4 covers the front side of the cut-out portion 23 of the light guide plate 2 and is inserted into the slit groove 51 of the light guide plate positioning portion 5. Further, as shown in FIG. 3, a gap is formed between the deepest surface 512 of the slit groove 51 of the light guide plate positioning portion 5 and the optical sheet 4, and thus even when the optical sheet 4 is thermally deformed, it is possible to suppress a situation where the optical sheet 4 is pressed to be deflected or bent by the light guide plate positioning portion 5 and thus causes a brightness distribution of light that has passed through the optical sheet 4 to vary. Furthermore, even when bending has occurred in the light guide plate 2, since there is a gap between each of a front surface and a rear surface of the optical sheet 4 and the parallel surfaces 511 of the slit groove 51, it is possible to suppress a situation where the slit groove 51 of the light guide plate positioning portion 5 and the optical sheet 4 come in contact with each other.

The gap between each of the surfaces 511 and 512 of the slit groove 51 of the light guide plate positioning portion 5 and the optical sheet 4 has such a size that, when the light guide plate 2 and(or) the optical sheet 4 are deformed due to heat generated in the backlight unit 1, each of the surfaces 511 and 512 of the slit groove 51 and the optical sheet 4 do not come in contact with each other or they come in contact with each other to an extent that no thermal stress is generated.

Furthermore, fastening of the light guide plate 2 and fastening of the optical sheet 4 are performed not simultaneously with each other. Thus, even when the light guide plate 2 and the optical sheet 4 are thermally deformed in different amounts from each other, it is possible to suppress the occurrence of defects such as wrinkling, slack, or breakage in the light guide plate 2 and(or) the optical sheet 4 due to such a difference in thermal deformation amount.

### Second Embodiment

A description is given of another example of the backlight unit according to the present invention with reference to the appended drawings. FIG. 4 is a front view of another example of the backlight unit according to the present invention, FIG. 5 is an enlarged view of a vicinity of a light guide plate positioning portion of a backlight unit shown in FIG. 4, and FIG. 6 is a sectional view of the backlight unit shown in FIG. 5, as taken on line VI-VI. As shown in FIGS. 4 and 5, a backlight unit 1B has the same configuration as that of the backlight unit 1 shown in the first embodiment except for a light guide plate holding-down portion 6 that holds down each of end portions of a light guide plate 2 in a long length direction thereof and an optical sheet 4b, and constituent components that are practically the same as those of the backlight unit 1 are indicated by the same reference characters.

The backlight unit 1B according to the present invention includes the light guide plate holding-down portion 6 that holds down, from a front side, to-be-held-down portions 24 at each of both end portions of a light emission surface 21 of the light guide plate 2 in the long length direction. Similarly to a light guide plate positioning portion 5, the light guide plate holding-down portion 6 is mounted to a mounting portion 101. The light guide plate holding-down portion 6 is formed so as not to hold down the light guide plate 2 in a vicinity of the light guide plate positioning portion 5.

A description is given of details of the light guide plate holding-down portion 6. The light guide plate holding-down portion 6 includes two rod-shaped members 61 that hold down end portions of the light guide plate 2 in a short length direction thereof. The rod-shaped members 61 make contact with the light guide plate 2 and hold down the light guide plate 2 toward a back chassis 10. Further, the two rod-shaped members 61 are linearly disposed with a clearance 60 provided therebetween. In an area overlapping the clearance 60 at a center in plan view, the light guide plate positioning portion 5 is disposed.

Furthermore, as shown in FIGS. 5 and 6, the optical sheet 4b includes a pair of extended portions 40b that extend outward in a long length direction thereof from a center portion at each of both end portions thereof in the long length direction and are formed so as to be away from each other in a short length direction thereof. The optical sheet 4b is disposed on the light guide plate 2 such that, in front view, the optical sheet 4b does not overlap the rod-shaped members 61, i.e. such that the optical sheet 4b is not held down by the rod-shaped members 61. Further, in the clearance 60, the pair of extended portions 40b are disposed so as to make contact with both sides of the light guide plate positioning portion 5.

In this manner, positioning of the optical sheet 4b in a short length direction of the backlight unit 1B is achieved. The extended portions 40b may be formed at each of a diffusion sheet 41, a brightness enhancement sheet 42, and a prism sheet 43, which constitute the optical sheet 4b, or alternatively, in a case of a configuration in which these optical sheet members do not move relative to each other, the extended portions 40b may be formed at any one of the optical sheet members.

In summary, positioning of each of the light guide plate 2 and the optical sheet 4b is achieved by using the light guide plate positioning portion 5. That is, positioning of the optical sheet 4b also is achieved by using the light guide plate positioning portion 5, and thus relative positioning between the light guide plate 2 and the optical sheet 4b is achieved. Furthermore, the optical sheet 4b has a clearance portion 401b that is formed between the pair of extended portions 40b so as to extend outward with respect to other portions of each of the end portions of the optical sheet 4b in the long length direction. Further, when the optical sheet 4b is disposed on a front side of the light guide plate 2b, the clearance portion 401b is disposed inside a slit groove 51 of the light guide plate positioning portion 5. As a result of this configuration, the optical sheet 4b covers, with the pair of extended portions 40b and the clearance portion 401b, a front side of a cut-out portion 23 of the light guide plate 2. While it is preferable that the clearance portion 401b be formed at each of all of the diffusion sheet 41, the brightness enhancement sheet 42, and the prism sheet 43, a configuration also may be adopted in which the clearance portion 401b is formed at at least one of them.

Leakage light that has leaked from the cut-out portion 23 of the light guide plate 2 and passed through a gap between the cut-out portion 23 and the light guide plate positioning portion 5 is dispersed by the optical sheet 4b, and thus it is possible to suppress the occurrence of unevenness in a brightness distribution of planar light emitted from the backlight unit 1B.

Further, in most cases, the light guide plate 2 and the optical sheet 4b are made of different materials from each other and thus are different in terms of an amount of their expansion due to heat. Since the optical sheet 4b is not held down by the light guide plate holding-down portion 6 (rod-shaped members 61), even when there occurs a difference in deformation amount between the light guide plate 2 and the optical sheet 4b, it is possible to suppress defects such as deflection or distortion in the optical sheet 4b or breakage of the optical sheet 4b due to an excessive force acting thereon. Thus, it is possible to suppress brightness unevenness of planar light emitted from the backlight unit 1B. In a case of this configuration, it is preferable that a margin for deformation of the optical sheet 4b due to its thermal expansion be formed between the light guide plate holding-down portion 6 and the optical sheet 4b.

Furthermore, while the backlight unit 1B includes the light guide plate holding-down portion 6 having the clearance 60, there is no limitation thereto, and the rod-shaped members 61 may be disposed onto the mounting portion 101 such that they make contact with the light guide plate positioning portion 5, in other words, such that the clearance 60 is not formed therebetween. In a case of this configuration, it is preferable that a margin for deformation of the optical sheet 4b due to its thermal expansion be formed between the light guide plate holding-down portion 6 and the optical sheet 4b. Furthermore, leakage light from the cut-out portion 23 also is homogenized by using the optical sheet 4 and used in that state, and thus use efficiency of light from the light source is high, so that energy consumption can be reduced correspondingly.

### Third Embodiment

A description is given of a liquid-crystal display device using the backlight unit according to the present invention with reference to the appended drawings. FIG. 7 is an exploded perspective view of a liquid-crystal display device according to the present invention, and FIG. 8 is a rear view of the liquid-crystal display device according to the present invention in a state where a back chassis has been removed therefrom. FIG. 9 is an enlarged view of a light guide plate positioning portion of the liquid-crystal display device according to the present invention, and FIG. 10 is a sectional view of the liquid-crystal display device shown in FIG. 9, as taken on line X-X.

As shown in FIG. 7, a liquid-crystal display device A includes a backlight unit 1B, a liquid-crystal panel unit 7, and an appearance frame 8. In the liquid-crystal display device A shown in FIG. 7, the backlight unit 1B shown in FIG. 4 is practically adopted while being partly changed so as to be suited for use in the liquid-crystal display device A. The following describes only differences from the backlight unit 1B shown in FIG. 4. Furthermore, there is no limitation to the backlight unit 1B, and the backlight unit 1 shown in FIG. 1 and so on also may be adopted.

The liquid-crystal panel unit 7 has a liquid-crystal panel 71 in which liquid crystal is sealed and a polarization plate 72 attached to each of a front surface (on a viewer side) and a rear surface (on a backlight unit 1B side) of the liquid-crystal panel 71. The liquid-crystal panel 71 includes an array substrate 711, an opposed substrate 712 disposed so as to be opposed to the array substrate 711, and liquid crystal filled between the array substrate and the opposed substrate (see FIG. 7).

In the array substrate 711, there are provided a source wiring line and a gate wiring line orthogonal to each other, a switching element (for example, a thin film transistor) connected to the source wiring line and to the gate wiring line, a pixel electrode and an alignment film connected to the switching element, and so on. Further, in the opposed substrate 712, there are provided a color filter in which coloring portions of red, green, and blue (RGB) are disposed in a predetermined arrangement, a common electrode, an alignment film, and so on.

In the liquid-crystal panel unit 7, the switching element is driven, causing a voltage to be applied between the array substrate 711 and the opposed substrate 712 in each pixel of the liquid-crystal panel 71. The voltage between the array substrate 711 and the opposed substrate 712 varies to cause liquid crystal in each pixel to rotate, as a result of which light is modulated (the degree of transmission of light is changed). Thus, an image is displayed in an image display region of the liquid-crystal panel 71 on the viewer side.

The appearance frame 8 is a frame body made of metal and has a shape to cover side edge portions of a front surface of the liquid-crystal panel unit 7. The appearance frame 8 includes a rectangular opening window 80 formed so as not to hide a video image display region of the liquid-crystal panel unit 7, a holding-down portion 81 that holds down the liquid-crystal panel unit 7 from a front side, and a cover portion 82 that protrudes from side edge portions of the holding-down portion 81 to a rear side and covers side edge portions of each of the liquid-crystal panel unit 7 and the backlight unit 1B. The appearance frame 8 is grounded and shields the liquid-crystal panel unit 7 and the backlight unit 1B.

As shown in FIG. 10, a light guide plate positioning portion 5 is fastened with a screw to the cover portion 82 of the appearance frame 8. Furthermore, a light guide plate holding-down portion 6 is mounted to the holding-down portion 6 of the appearance frame 8. That is, when the liquid-crystal panel unit 7 is disposed on a front side of the backlight unit 1B, and then the appearance frame 8 is mounted thereto from the front side, the light guide plate positioning portion 5 is engaged with a cut-out portion 23 of a light guide plate 2, and thus positioning of each of the appearance frame 8 and the light guide plate 2 is achieved. At this time, an optical sheet 4b is inserted into a slit groove 51 of the light guide plate positioning portion 5, and this makes it possible for the optical sheet 4b to cover a front surface of the light guide plate 2 including the cut-out portion 23. Thus, light leaked from the cut-out portion 23 can be suppressed.

The light guide plate holding-down portion 6 may be formed of a single rod-shaped member 61 that is formed to have a width smaller at a portion thereof where a clearance 60 would otherwise be provided than at any other portion thereof so that the light guide plate positioning portion 5 and an extended portion 40b of the optical sheet 4b can be inserted thereinto. In such a case, since the light guide plate holding-down portion 6 is formed as a single body, it is possible to reduce work necessary for positioning and mounting of the light guide plate holding-down portion 6.

Furthermore, since the light guide plate positioning portion 5 and the light guide plate holding-down portion 6 are mounted to the appearance frame 8, a mounting portion 101 can be omitted. Thus, the number of constituent members of the liquid-crystal display device A can be reduced. Furthermore, unlike a conventional case, there is no need for a frame for blocking light leaking from the cut-out portion 23, and also in this sense, it is possible, while suppressing deterioration in quality of a displayed image, to reduce the number of constituent members of the liquid-crystal display device A. Furthermore, leakage light from the cut-out portion 23 also is homogenized by using the optical sheet 4 and used in that state, and thus use efficiency of light from the light source is high, so that energy consumption can be reduced correspondingly.

While each of the foregoing embodiments describes, as an example, a case where the cut-out portion is formed at a center of each of end portions of the light guide plate in the long length direction, there is no limitation thereto, and the cut-out portion may be formed at a location displaced from the center. Furthermore, while a single cut-out portion is provided at each of both the end portions, there is no limitation thereto, and a plurality of cut-out portions may be formed at each of both the end portions, or the number of cut-out portions formed at one of both the end portions does not have to be the same as the number of cut-out portions formed at the other of the end portions. Moreover, a configuration may be adopted in which a plurality of cut-out portions are formed at one side. In addition, while the cut-out portion is assumed to have a rectangular shape having inner surfaces parallel to three side surfaces of the light guide plate, the cut-out portion may be formed in a quadrangular shape in plan view whose inner surfaces form a given angle with the side surfaces of the light guide plate, or may have a V-shape in plan view or a semicircular shape in plan view. As a structure of the cut-out portion, there can be adopted any structure that enables positioning of each of the light guide plate and the optical sheet and in which the slit groove capable of housing each of end portions of the optical sheet can be formed.

The foregoing has described the embodiments of the present invention but is not to be construed as limiting the present invention thereto. Furthermore, the embodiments of the present invention may be variously modified without departing from the spirit of the invention.

### INDUSTRIAL APPLICABILITY

The backlight unit and the liquid-crystal display device according to the present invention can be used as a display portion of electronic apparatuses such as information household electric appliances, notebook personal computers, mobile telephones, and game devices.

### LIST OF REFERENCE SYMBOLS

1 backlight unit

2 light guide plate

21 light emission surface

22 light reception surface

23 cut-out portion

3 light source unit

30 substrate

31 LED

4 optical sheet

41 diffusion sheet

42 brightness enhancement sheet

43 prism sheet

5 light guide plate positioning portion

51 slit groove

6 light guide plate holding-down portion

61 rod-shaped member

7 liquid-crystal panel unit

71 liquid-crystal panel

711 array substrate

712 opposed substrate

72 polarization plate

8 appearance chassis

81 holding-down portion

82 cover portion

1-9. (canceled)

10. A backlight unit, comprising:
a light guide plate that includes, at a side portion thereof, a light reception surface that receives light and, at a principal surface thereof on a front side, a light emission surface from which planar light is emitted, and has a cut-out portion formed at a side portion thereof different from the side portion at which the light reception surface is formed;
a light source unit that irradiates the light reception surface with light;
a back chassis on which the light source unit and the light guide plate are disposed;
an optical sheet that is disposed in proximity to the light emission surface of the light guide plate and covers a front side of the cut-out portion; and
a light guide plate positioning portion that is disposed so as to be maintained at a constant position with respect to the back chassis, is engaged with the cut-out portion, and has a slit groove formed to receive insertion of a part of the optical sheet.

11. The backlight unit according to claim 10, wherein
the optical sheet has a pair of extended portions that extend so as to make contact with both sides of the light guide plate positioning portion.

12. The backlight unit according to claim 10, further comprising:
a light guide plate holding-down portion that presses, toward the back chassis, a portion of the light emission surface of the light guide plate other than a portion of the light emission surface at which the cut-out portion is formed,
wherein the optical sheet is formed so as not to make contact with the light guide plate holding-down portion.

13. The backlight unit according to claim 12, wherein
the light guide plate holding-down portion includes a pair of rod-shaped members that hold down the light guide plate, and
the pair of rod-shaped members are disposed side by side with a gap provided therebetween in an area overlapping, in front view, a pair of extended portions of the optical sheet, which extend so as to make contact with both sides of the light guide plate positioning portion.

14. A liquid-crystal display device, comprising:
the backlight unit according to claim 10;
a liquid-crystal panel unit that is disposed in front of the backlight unit; and
an appearance frame that covers an outer edge portion of each of the backlight unit and the liquid-crystal panel unit and to which the light guide plate positioning portion is mounted.

15. The liquid-crystal display device according to claim 14, wherein
the appearance frame includes a cover portion that covers an outer periphery of the backlight unit, and
the light guide plate positioning portion is fastened to the cover portion.

16. A liquid-crystal display device, comprising:
the backlight unit according to claim 12;
a liquid-crystal panel unit that is disposed in front of the backlight unit; and
an appearance frame that covers an outer edge portion of each of the backlight unit and the liquid-crystal panel unit,
wherein
the light guide plate positioning portion is mounted and fastened to the appearance frame.

17. The liquid-crystal display device according to claim 16, wherein
the appearance frame includes a cover portion that covers an outer periphery of the backlight unit, and
the light guide plate positioning portion is fastened to the cover portion.

18. The liquid-crystal display device according to claim 16, wherein
the appearance frame includes a holding-down portion that presses an outer periphery of a front surface of each of the backlight unit and the liquid-crystal panel unit, and
the light guide plate holding-down portion is fastened to the holding-down portion.
